(19) United States
(12) Patent Application Publication
(10) Pub. No.: US 2007/0041050 A1
(43) Pub. Date: Feb. 22, 2007

(54) MEMORY MANAGEMENT METHOD AND SYSTEM

(76) Inventor: Bing-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/428,838

(22) Filed: Jul. 6, 2006

Related U.S. Application Data
(60) Provisional application No. 60/708,798, filed on Aug. 17, 2005.

(51) Int. Cl. G06K 15/00

(52) U.S. Cl. 358/1.16

(57) ABSTRACT

A memory management method applied to a storage device is disclosed. The storage device has a plurality of storage units. The memory management method includes: providing a buffer storage device comprising a buffer space, wherein the size of the buffer space is equal to the size of each storage unit; receiving an input data transmitted via at least an access unit, and storing the input data into the buffer space of the buffer storage device, wherein the size of the access unit is different from the size of each storage unit; and writing the input data into the storage device by transferring data stored in the buffer space into a first storage unit of the storage units in the storage device when the buffer space is full.

### CROSS REFERENCE TO RELATED APPLICATIIONS

The application claims the benefit of U.S. Provisional Application No. 60/708,798, which was filed on Aug. 17, 2005 and is included herein by reference.

### BACKGROUND

The disclosure relates to a method and system for accessing data, and more specifically, to a memory management method and related memory management system using a buffer storage module to buffer data transmitted between two storage devices having basic data access units of different sizes.

### DESCRIPTION OF THE PRIOR ART

In a file system, such as an FAT (File Allocation System) file system that is generally supported or utilized in DOS, Windows and OS/2, a storage disk is logically divided into clusters that are each further divided into a plurality of sectors. For example, a cluster has four 512-byte sectors. A sector is a smallest access unit of the FAT file system. A nonvolatile storage device, such as a flash memory device, is logically divided into a plurality of basic storage units, and a file is composed of a certain number of such basic storage units. For example, a basic storage unit of a flash memory device is a 512-byte page.

The FAT file system can access the flash memory device via a driver, and the driver retrieves or updates data stored in the flash memory device. In a related art, the page size is the same as the sector size, meaning each page of the flash memory device corresponds to one sector in the FAT file system. However, due to the high capacity demand, modern flash memory devices have larger page sizes, e.g. 2K bytes, to offer better storage performance. The mismatch between the sector size and the page size creates a problem. A related art scheme provides a method in which the sector size is enlarged to be equal to the page size. In this related art, however, the FAT file system needs to occupy a part of a RAM device of an electronic system that adopts the FAT file system, significantly increasing the cost of the electronic system.

### SUMMARY OF THE INVENTION

It is therefore one of the objectives of the claimed invention to provide a memory management method and related memory management system using a buffer storage module to buffer data transmitted between two storage devices having basic data access units of different sizes.

According to an embodiment of the disclosure, a memory management method applied to a storage device is provided. The storage device comprises a plurality of storage units. The memory management method comprises: providing a buffer storage device comprising a buffer space, wherein the size of the buffer space is equal to the size of each storage unit; receiving an input data transmitted via at least an access unit, and storing the input data into the buffer space of the buffer storage device, wherein the size of the access unit is different from the size of each storage unit; and writing the input data into the storage device by transferring data stored in the buffer space into a first storage unit of the storage units in the storage device when the buffer space is full.

According to an embodiment of the disclosure, a memory management system is provided. The memory management system comprises: a data source providing an input data in at least an access unit; a storage device comprising a plurality of storage units, wherein the size of the access unit is different from the size of each storage unit; a buffer storage device comprising a buffer space, wherein the size of the buffer space is equal to the size of each storage unit; and a storage device controller, coupled to the data source, the storage device and the buffer storage device, for receiving the input data transmitted via the access unit; storing the input data into the buffer space of the buffer storage device; and writing the input data into the storage device by transferring data stored in the buffer space into a first storage unit of the storage units in the storage device when the buffer space is full.

Compared to the related art, the size of the access unit of the FAT file system and the size of the storage unit of the flash module do not need to be modified to be equal. In addition, the cost of the present invention electronic device is not significantly increased, and higher read/write throughputs as mass storage usage can be provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a memory management system according to an embodiment of the present invention.

FIG. 2 is a diagram of a data writing operation according to an embodiment of the present invention.

FIG. 3 is a diagram of a data reading operation according to an embodiment of the present invention.

FIG. 4 is a diagram of the data reading operation according to another embodiment of the present invention.

FIG. 5 is a diagram of a data modifying operation according to an embodiment of the present invention.

### DETAILED DESCRIPTION

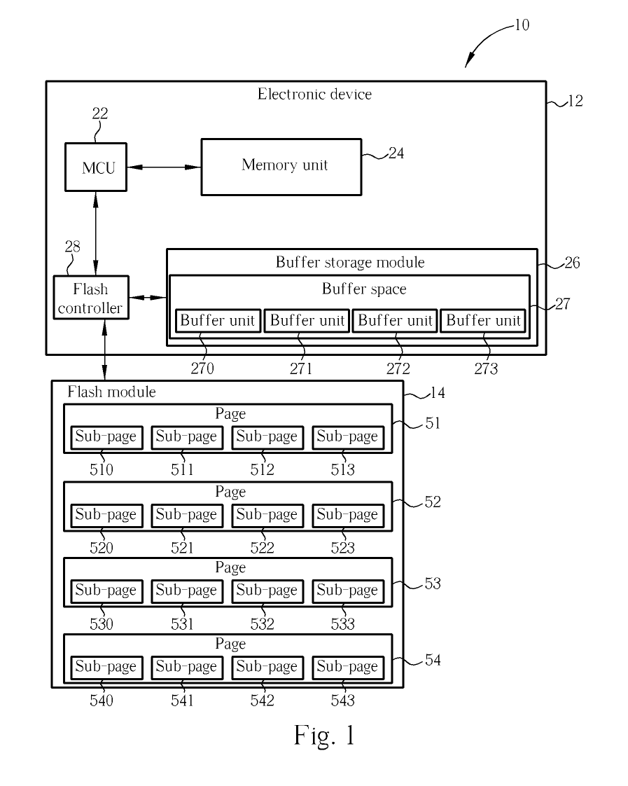

Please refer to FIG. 1. FIG. 1 is a block diagram of a memory management system 10 according to an embodiment of the present invention. In this embodiment, the memory management system 10 comprises an electronic device (e.g. a base band chip, mobile phone or digital camera) 12 and a flash module 14. The electronic device 12 comprises a micro-control unit (MCU) 22, a memory unit 24 acting as a data source, a buffer storage module 26 acting as a buffer storage device, and a flash controller 28 acting as a storage device. To better illustrate features of the present invention, assume that the electronic device 10 in the present embodiment adopts an FAT file system. The memory unit 24, coupled to the MCU 22, is utilized for storing data according to at least an access unit where an access unit represents the smallest unit adopted by the FAT file system for data accessing, and in the present embodiment, the access unit is a 512-byte FAT sector. In the present embodiment, the data stored in the memory unit 24 comprises drivers (including a flash driver of the flash module 14), file system software, and various software applications. The MCU 22, coupled to the memory unit 24 and the flash controller 28, is utilized for executing the data (e.g. the flash driver) stored in the memory unit 24. The flash module 14, coupled to the electronic device 12, is utilized for storing data that may be utilized by the executions of program execution codes stored in the memory unit 24, such as system settings and user data. As known to those skilled in this art, the flash module 14 comprises a plurality of storage units where a storage unit is the smallest access unit in the flash module 14, and in the present embodiment, a storage unit is a 2K-byte page. The size of the access unit in the memory unit 24 is different from the size of each storage unit in the flash module 14; for example, a 2K-byte page (i.e. one storage unit) corresponds to four 512-byte sectors (i.e. four access units). Please note that in other embodiments of the present invention, sizes of an access unit and a storage unit may be changed to other values according to different design requirements, and these changes still fall within the scope of the present invention. In addition, as shown in FIG. 1, the MCU 22, the memory unit 24, the buffer storage module 26, and the flash controller 28 are embedded in the electronic device 12. However, the present invention is not limited to this configuration.

In this embodiment, the buffer storage module 26, coupled to the flash controller 28, comprises a buffer space 27, where the size of the buffer space 27 is equal to the size of each storage unit in the flash module 14. As shown in FIG. 1, the buffer space 27 comprises a plurality of buffer units, where each buffer unit is the smallest access unit in the buffer storage module 26, and in the present embodiment, the size of a buffer unit is equal to the size of an access unit in the memory unit 24; meaning the size of the buffer unit is 512 bytes. Please note that the buffer storage module 26 is not limited to have four buffer units only. In other words, the buffer storage module 26 can be designed to include a plurality of buffer spaces for offering better buffering capacity.

The flash controller 28, coupled to the MCU 22, the flash module 14 and the buffer storage module 26, controls data access (i.e. data reading or data writing) of the flash module 14. Detailed descriptions of the buffer storage module 26 and the flash controller 28 are provided as below. Please note that in other embodiments of the present invention, the flash module 14 can be replaced with other storage devices and the flash controller 28 can be other storage controllers implemented by software or hardware means. In addition, the electronic device 12 can be replaced with other operating modules and can adopt other file systems. As shown in FIG. 1, the buffer space 27 of the buffer storage module 26 is 2K bytes in size and comprises buffer units 270, 271, 272, and 273. The flash module 14 comprises a plurality of pages, including pages 51, 52, 53, and 54. In the present embodiment, each of the pages 51, 52, 53, and 54 comprises four sub-pages (sub-pages 510-513, 520-523, 530-533, 540-543, respectively). The size of each sub-page is equal to the size of an access unit.

When the MCU 22 executes an application (of the above-mentioned software applications) and the application requires accessing data stored in the flash module 14, the application calls for primitive operations of the FAT file system, or functions further invoke corresponding primitive operations, including a data writing operation, a data reading operation and a data modifying operation. The primitive operations further call the flash driver of the flash module 14 to drive the corresponding flash controller 28 that physically accesses the flash module 14. The flash driver calculates a page address (of a certain page in the flash module 14) according to a sector address provided by the FAT file system and accesses data stored in the flash module 14. The data retrieved from the flash module 14 page by page is temporarily stored in the buffer space 27 and then parts or the whole of the data stored in the buffer space 27 will be transmitted to the FAT file system sector by sector. That is, the FAT file system further transmits the requested data sector by sector to the application. The detailed descriptions of accessing data stored in the flash module 14, including the above-mentioned data writing, data reading, and data modifying operations, are provided in the following paragraphs.

Through the above description, a general embodiment of a memory management method can be described as follows. The memory management method is used for handling a set of primitive operations under an access unit size, e.g. sector size, of a file system, e.g. FAT system, to access a storage device, e.g. a flash memory, that stores data under a storage unit size, e.g. page size. As illustrated above as an example, the sector size is 512 bytes and the page size is 2K bytes. The memory management method can be implemented as a memory driver in software or firmware or digital logic circuits. The memory driver, the file system and the storage device are installed in an electronic apparatus, e.g. a mobile phone or a mobile device.

Alternatively, the memory driver and storage driver is installed in a first electronic apparatus and the storage device is installed in a second electronic apparatus. For example, the first electronic apparatus is a personal computer and the second electronic apparatus is a mobile phone equipped with a flash memory. Between the first electronic apparatus and the second electronic apparatus are a communication link and associated software and hardware, e.g. USB driver and USB signal lines. When the second electronic apparatus is regarded as an external memory device by the first electronic apparatus, the memory driver is installed on the first electronic apparatus. The memory driver receives the primitive operation and translates them into corresponding instructions according the actual storage device, i.e. using storage unit size and associated storage unit address. In addition, communication protocols are incorporated in the driver in such case. As an alternative practice, the memory driver can also be installed on the second electronic apparatus. In such case, corresponding codes need to be adjusted according to such configuration.

The memory management method can be summarized to include: receiving the primitive operation, which indicates one access unit address; translating the access unit address into at least one corresponding storage unit address; and accessing the storage unit using the translated storage unit address for responding the received primitive operation. The primitive operation can be reading, writing or other data access instructions, e.g. erasing. When the primitive operation is reading and the access unit size is smaller than the storage unit size, a storage unit is retrieved and buffered but only a portion of the storage unit is transmitted to the software that requests the data. When the primitive operation is writing and the access unit size is smaller than the storage unit size, an associated storage unit, including the access unit of the appointed access unit address and access units adjacent to the appointed access unit, is stored into a buffer. Then, the appointed access unit in the buffer to be updated is written with assigned value. Then, the buffer is written back to the storage device.

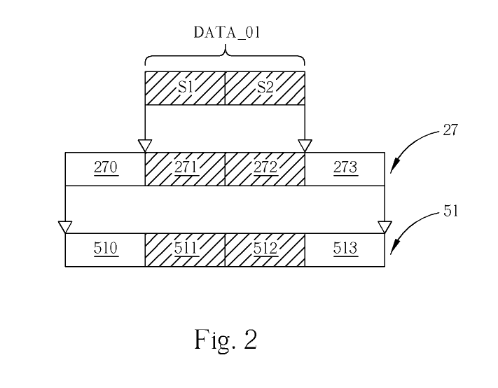

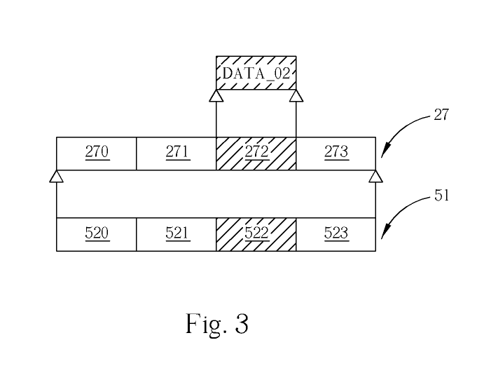

Please refer to FIG. 2. FIG. 2 is a diagram of a data writing operation according to an embodiment of the present invention. Assume the MCU 22 requires storing first desired data DATA_01 stored in two sectors S1 and S2 to the flash module 14. As mentioned above, the smallest storage unit in the flash module 14 is a page four times the size of a sector, and therefore the first desired data DATA_01 stored in the sectors S1 and S2 cannot be directly stored into the flash module 14. In the data writing operation, the first desired data DATA_01 stored in the sectors S1 and S2 is first written into buffer units 271 and 272 of the buffer space 27, respectively, as shown in FIG. 3. The rest of the buffer space 27, including the buffer units 270 and 273, are then filled with dummy data, wherein the dummy data comprises logic values in this embodiment, and each logic value corresponds to an erase state of the flash module 14. Afterwards, the flash controller 28 writes the data stored in the buffer space 27 (in page size) into the page 51 of the flash module 14. As shown in FIG. 2, the page 51 comprises four sub-pages 510, 511, 512, and 513, corresponding to the buffer units 270, 271, 272, and 273, respectively. Hence, the goal of writing the first desired data DATA_01 stored in the sectors S1 and S2 into the flash module 14 by utilizing the buffer space 27 of the storage module 26 can be achieved. In addition, the dummy data is stored in the buffer units 270 and 273 in two methods. A first method is to fill the buffer space 27 (i.e. all of the buffer units 271, 272, 273 and 274) with the dummy data before the first desired data DATA_01 is stored in the buffer space 27 (i.e. the buffer units 271 and 272 in the present embodiment). The other method is to fill the buffer units 270 and 273 with the dummy data after the first desired data DATA_01 is stored in the buffer units 271 and 272. Either of the above-mentioned methods is applicable; however, the present invention is not limited to the aforementioned two ways.

Please refer to FIG. 3. FIG. 3 is a diagram of a data reading operation according to an embodiment of the present invention. Assume the MCU 22 requires reading second desired data DATA_02 stored in the sub-page 522 of the flash module 14. In the data reading operation, the flash controller 28, driven by the flash driver, first copies all data, including the second desired data DATA_02, stored in the page 52 to the buffer space 27. At this time, the data stored in the buffer units 270, 271, 272 and 273 is the same as the data stored in the sub-pages 520, 521, 522 and 523, respectively. Afterwards, the flash driver drives the flash controller 28 to transmit the second desired data DATA_02 stored in the buffer unit 272 to the FAT file system, thereby completing the data reading operation.

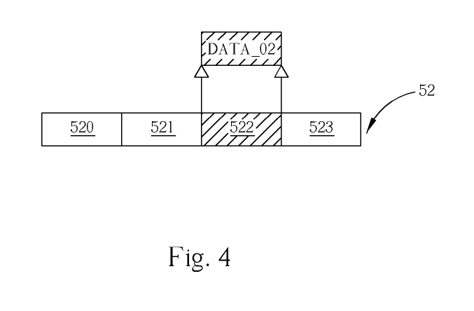

Please refer to FIG. 4. FIG. 4 is a diagram of the data reading operation according to another embodiment of the present invention. Assume the MCU 22 requires reading second desired data DATA_02 stored in the sub-page 522 of the flash module 14. In the present data reading operation, the flash controller 28, driven by the flash driver, directly reads and transmits the second desired data DATA_02 stored in the sub-page 522 to the FAT file system without utilizing the buffer space 27. The same objective of reading the second desired data DATA_02 is achieved.

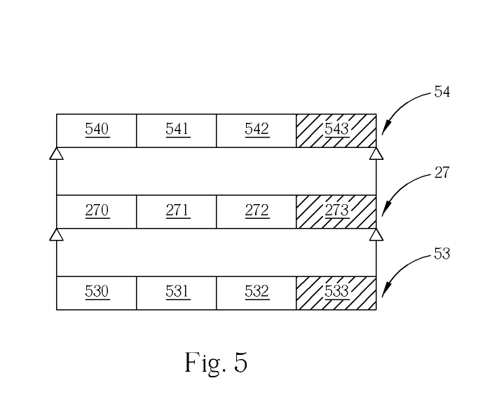

Please refer to FIG. 5. FIG. 5 is a diagram of a data modifying operation according to an embodiment of the present invention. Assume the MCU 22 requires modifying specific data stored in the sub-page 533 of the page 53 in the flash module 14. As mentioned above, the smallest storage unit in the flash module 14 is a page, and therefore the specific data stored in the sub-page 533 cannot be modified and stored back to the flash module 14 directly. In the data modifying operation, the flash controller 28, driven by the flash driver, first copies all data stored in the page 53 to the buffer space 27. At this time, the data stored in the buffer-units 270, 271, 272 and 273 is the same as the data stored in the sub-pages 530, 531, 532 and 533, respectively. The flash controller 28 then modifies the specific data stored in the buffer-unit 273. Afterwards, the flash controller 28 writes the data stored in the buffer space 27 back to another page 54 of the flash module 14 where information written into sub-page 543 is different from that stored in the sub-page 53. In other words, since the data stored in the buffer-units 270, 271, 272 and 273 is the same as the data stored in the sub-pages 540, 541, 542 and 543, respectively, the modified specific data is stored in the sub-page 543 successfully.

With the above inventive concept, the size of the access unit of the FAT file system and the size of the storage unit of the flash module do not need to be modified to be the same. In addition, the cost of the present invention electronic device is not significantly increased, and a higher read/write throughputs as mass storage usage can be provided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory management method for handling a set of primitive operations under an access unit size of a file system to access a storage device that stores data under a storage unit size, comprising:
receiving the primitive operation indicating at least one access unit address;
translating the access unit address into at least one corresponding storage unit address, wherein the storage unit size is different as the access unit size; and
accessing the storage device using the storage unit address for responding the primitive operation.

2. The method of claim 1, wherein when the primitive operation is reading and the access unit is smaller than the storage unit size, the method further comprises:
buffering a retrieved storage unit appointed by the storage unit address and providing only a portion of the retrieved storage unit for responding the primitive operation.

3. The method of claim 1, wherein when the primitive operation is writing and the access unit size is smaller than the storage unit size, the method further comprises:
reading a storage unit corresponding to the access unit address into a buffer, the storage unit containing an access unit appointed by the access unit address to be written and one or more adjacent access units, the total size of the appointed access unit and the adjacent access units equals to the size of one storage unit;
updating the appointed access unit to be written with an assigned value; and
writing the buffer into the storage device.

4. The method of claim 1, wherein a storage driver, the file system and the storage device are installed on an electronic apparatus, and software applications of the electronic apparatus access the storage device using the set of primitive operations, and the primitive operations are passed to the storage driver for performing the steps of receiving the primitive operations, translating the primitive operations and accessing the storage device.

5. The method of claim 1, wherein a storage driver and the file system are installed in a first electronic apparatus and the storage device is installed in a second electronic apparatus, software applications of the first electronic apparatus access the storage device using the set of primitive operations, and the primitive operations are passed to the storage driver for performing the steps of receiving the primitive operations, translating the primitive operations and accessing the storage device.

6. The method of claim 1, wherein the storage device is a flash memory.

7. The method of claim 6, wherein the storage unit size is page size of the flash memory and the access unit size is sector size of the file system.

8. A memory management method applied to a storage device, the storage device comprising a plurality of storage units, the memory management method comprising:
providing a buffer storage device comprising at least a buffer space, wherein the size of the buffer space is equal to the size of each storage unit;
receiving an input data transmitted via at least an access unit, and storing the input data into the buffer space of the buffer storage device, wherein the size of the access unit is different from the size of each storage unit; and
writing the input data into the storage device by transferring data stored in the buffer space into a first storage unit of the storage units in the storage device when the buffer space is full.

9. The method of claim 8, wherein the storage device is a flash memory.

10. The method of claim 9, further comprising:
after the input data is stored in the buffer space, filling the buffer space with a dummy data except space occupied by the input data.

11. The method of claim 10, wherein the dummy data comprises logic values, and each logic value corresponds to an erase state of the flash memory.

12. The method of claim 9, further comprising:
filling the buffer space with a dummy data before the input data is stored in the buffer space.

13. The method of claim 12, wherein the dummy data comprises logic values, and each logic value corresponds to an erase state of the flash memory.

14. The method of claim 8, wherein the size of the storage unit is greater than the size of the access unit.

15. The method of claim 8, further comprising:
when receiving a request for modifying the input data, copying the input data stored in the first storage unit to the buffer space; modifying data stored in the buffer space;
and transferring the modified input data stored in the buffer space into a second storage unit of the storage units in the storage device.

16. The method of claim 8, further comprising:
when receiving a request for reading the input data, copying the data stored in the first storage unit to the buffer space; and reading the input data stored in the buffer space.

17. A memory management system, comprising:
a data source, providing an input data in at least an access unit;
a storage device comprising a plurality of storage units, wherein the size of the access unit is different from the size of each storage unit;
a buffer storage device comprising at least a buffer space, wherein the size of the buffer space is equal to the size of each storage unit; and
a storage device controller, coupled to the data source, the storage device and the buffer storage device, for receiving the input data transmitted via the access unit;
storing the input data into the buffer space of the buffer storage device; and
writing the input data into the storage device by transferring data stored in the buffer space into a first storage unit of the storage units in the storage device when the buffer space is full.

18. The memory management system of claim 17, wherein the storage device is a flash memory.

19. The memory management system of claim 17, wherein the storage device controller fills the buffer space with a dummy data except space occupied by the input data after the input data is stored in the buffer space.

20. The memory management system of claim 19, wherein the dummy data comprises logic values, and each logic value corresponds to an erase state of the flash memory.

21. The memory management system of claim 18, wherein the storage device controller fills the buffer space with a dummy data before the input data is stored in the buffer space.

22. The memory management system of claim 21, wherein the dummy data comprises logic values, and each logic value corresponds to an erase state of the flash memory.

23. The memory management system of claim 17, wherein the size of the storage unit is greater than the size of the access unit.

24. The memory management system of claim 17, wherein when the storage device controller receives a request for modifying the input data, the storage device controller copies data stored in the first storage unit to the buffer space, modifies data stored in the buffer space, and transfers the modified input data stored in the buffer space into a second storage unit of the storage units in the storage device.

25. The memory management system of claim 17, wherein when the storage device controller receives a request for reading the input data, the storage device controller copies the data stored in the first storage unit to the buffer space, and reads the input data stored in the buffer space.
